(19) United States
(12) Patent Application Publication
(10) Pub. No.: US 2009/0126528 A1
(43) Pub. Date: May 21, 2009

(54) Pedal Structure for Traveling Vehicle

(76) Inventors: Kunihiko Sakamoto, Fukuoka (JP); Hayato Tsuji, Fukuoka (JP); Syoubu Aramaki, Fukuoka (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/065,841

(22) PCT Filed: Jan. 20, 2006
(86) PCT No.: PCT/JP2006/300803

§ 371 Date: May 5, 2008

(30) Foreign Application Priority Data
Sep. 5, 2005 (JP) 2005-256187

(51) Int. Cl. B62M 3/08

(52) U.S. Cl. 74/594.4

(57) ABSTRACT

An aspect of the invention provides a pedal structure for traveling vehicle with an operating pedal in which a simple and inexpensive configuration, a simple shape, and a sufficient antiskid effect can be obtained. In the pedal structure for traveling vehicle with the operating pedal, bent portions 61 are provided in end portions of a forward pedal 21 and a reverse pedal 22 which are of an operating pedal, the bent portion 61 is bent toward sides of stepping surfaces 21f and 22f while having an irregular shaped end face 60. The bent portions 61 are provided in opposite end portions of the pedals 21 and 22, and the forward pedal 21 and the reverse pedal 22 are formed in the same shape including an identification mark 62. The identification mark 62 indicating forward or reverse is provided by punching.

### TECHNICAL FIELD

The present invention relates to a technology of a pedal structure for traveling vehicle suitably used in a work vehicle such as a tractor.

### BACKGROUND ART

Conventionally, in work vehicles such as a tractor and a riding type lawn mower, operating pedals such as a gear shift pedal and a brake pedal are provided in an operating step of a drive portion, various techniques disclose structures of the operating pedals (for example, see Patent Document 1). In some of traveling vehicles including hydro static transmissions (hereinafter referred to as “HST”), a forward pedal and a reverse pedal which are of forward and reverse operating means are separately provided (for example, see Patent Document 2).

In some of the operating pedals, one rod-shape body is bent like independent brake pedals for right and left running wheels of the traveling vehicle. That is, a stepping portion in the operating pedal is formed in a rod shape provided in a substantially horizontal direction.

On the other hand, some of the operating pedals are provided in a lower front portion of a drive portion (under driver's foot) while the rod portion (arm portion) extended from a plate member such as an operating step is interposed. In such structure, a guide portion (opening portion) is formed in the plate member to permit the rod portion to be moved.

In the conventional operating pedal, because the stepping surface is formed in a substantial plane or slightly curved surface, the feet of the driver possibly becomes slippery due to rain water and dirt. Therefore, sometimes a slip stopper is formed in order to prevent wrong operation or to ensure safety. The slip stopper is provided by coating the operating pedal with rubber or by bonding slip stopper member such as rubber to the operating pedal, or grooves or irregularity is formed in the stepping surface by casting. Therefore, when the slip stopper is formed in the operating pedal, because cost or the number of manufacturing processes is increased, sometimes the sufficient antiskid effect is not obtained. In particular, in the case where the forward pedal and the reverse pedal are separately provided, when an identification mark such as an arrow indicating forward or reverse is formed in the stepping surface as shown in Patent Document 1, the forward pedal and the reverse pedal have different structures (shapes), which leads to cost increase from the viewpoint of part management.

As described above, in the operating pedal whose rod-shaped stepping portion is provided in the substantially horizontal direction, the compact pedal structure and good operability are obtained. At the same time, because the operating pedal has a small contact area with a shoe sole of the driver, the feet of the driver becomes slippery due to the rain water and dirt. For example, in the case where the rod-shaped operating pedal is used in the brake pedal, the wrong operation caused by the slip of the driver's foot should be avoided as much as possible from the standpoint of safety.

On the other hand, as described above, in the structure in which the operating pedal is provided while the rod portion is interposed, when an engine of the traveling vehicle is mounted in front of the driving portion, sometimes the feet of the driver is blown with hot air of the engine from the guide portion of the plate member into which the rod portion is inserted. Conventionally, in order to prevent the blow-in of the hot air of the engine, a rubber plate in which a notch is formed to permit the movement of the rod portion or a bellows-shaped member following the movement of the rod portion is used to close the guide portion. However, because usually the operating pedal is provided under the feet of the driver, when the operating pedal has the complicated structure, the dirt and trash remain easily, cleaning work becomes troublesome, and the operating pedal is easily broken.

Therefore, there is a need for a pedal structure for traveling vehicle with an operating pedal having simple and inexpensive configuration, simple shape, and sufficient antiskid effect. There is also a need for a pedal structure for traveling vehicle in which the hot air of the engine can be prevented from blowing from the guide portion, into which the rod portion where the operating pedal is provided is inserted, with the simple and durable structure.

Patent Document 1: Japanese Patent Application Laid-Open Publication No. 8-40102

Patent Document 2: Japanese Patent Application Laid-Open Publication No. 2004-330900

### DISCLOSURE OF THE INVENTION

### Problems to be Solved by the Invention

As described above, in the conventional structure of the operating pedal, when the slip stopper is formed in the operating pedal, the sufficient antiskid effect is not obtained, although the cost or the number of manufacturing processes is increased. Additionally, in order to prevent the hot air of the engine from blowing the feet of the driver in which the operating pedal is provided, unfortunately the dirt and trash remain easily due to the complicated structure.

In view of the foregoing, an object of the invention is to provide a pedal structure for traveling vehicle with the operating pedal in which the antiskid effect can sufficiently be obtained by the simple and inexpensive structure and the simple shape. Another object of the invention is to provide a pedal structure for traveling vehicle in which the hot air of the engine can be prevented from blowing from the guide portion, into which the rod portion where the operating pedal is provided is inserted, with the simple and durable structure.

### Means for Solving the Problems

In accordance with a first aspect of the invention, a pedal structure for traveling vehicle with an operating pedal, wherein a bent portion is provided in an end portion of the operating pedal, the bent portion being bent toward a stepping surface side while having an irregular shaped end face.

In the pedal structure for traveling vehicle according to the aspect of the invention, preferably the operating pedal is bent in a multi-step manner to form said bent portion, and a flat portion is provided in the operating pedal.

In the pedal structure for traveling vehicle according to the aspect of the invention, preferably an identification mark indicating running direction is provided in the operating pedal by punching. In the pedal structure for traveling vehicle according to the aspect of the invention, preferably not only the identification mark is used as a forward pedal indicating forward but also the identification mark is used as a reverse pedal indicating reverse by orientating the operating pedal toward opposite front-back directions.

In the pedal structure for traveling vehicle according to the aspect of the invention, preferably the bent portions are provided in opposite end portions of the operating pedal, and the forward pedal and the reverse pedal are formed in the same shape including said identification mark. In the pedal structure for traveling vehicle according to the first aspect of the invention, preferably bent portions are provided in both right and left end portions of the operating pedal, the bent portion having an irregular shaped end face, the bent portion being such that both the right and left end portions are orientated toward a stepping surface side in the center in a right and left direction of the operating pedal.

In accordance with a second aspect of the invention, a pedal structure for traveling vehicle with an operating pedal constituting a rod-shaped stepping portion disposed in a substantially horizontal direction, wherein a friction portion is formed in said operating pedal.

In the pedal structure for traveling vehicle according to the aspect of the invention, preferably a rod portion of an operating pedal is extended to a driving portion through a guide portion formed by an opening provided in a plate member, the driving portion and an engine room of the traveling vehicle being separated by the plate member, and a mold member having a width substantially identical to that of the guide portion is attached to the guide portion, the mold includes a closed portion and a clipping portion, the closed portion permitting the rod portion to be moved by elastic deformation while closing an opening portion formed between the guide portion and the rod portion, the clipping portion clipping the plate member.

### EFFECTS OF THE INVENTION

In the pedal structure for traveling vehicle of the invention, the antiskid effect can sufficiently be obtained by the simple and inexpensive structure and the simple shape. That is, when compared with the conventional stepping surface formed in the substantial plane or slightly curved surface, the bent shape of the bent portion which is projected from the stepping surface abuts on the shoe sole of the driver to act as the slip stopper by bending the end portion of the plate-like pedal, and the irregular-shaped end face of the bent portion creates friction with the shoe sole of the driver to act as the slip stopper, so that the antiskid effect can sufficiently be obtained. In the plate-like operating pedal, the irregular-shaped end face and bent plate are formed by press working, so that the bent portion can simply be formed at low cost.

In the pedal structure for traveling vehicle of the invention, a pressure against the shoe sole can be reduced from the end face of the bent portion formed in the irregular shape in the operating pedal to which a large stepping force is applied. Therefore, damage of the shoe sole of the driver can be prevented.

In the pedal structure for traveling vehicle of the invention, the identification mark and the bent portion which can be provided by press working are provided in the same process. Therefore, the number of processes is not increased when the identification mark is provided, and the simplified manufacturing process and cost reduction can be achieved. Additionally, when compared with the conventional technique of bonding the rubber plate having the identification mark such as the arrow to the operating pedal, the simplified manufacturing process and cost reduction can be achieved.

In the pedal structure for traveling vehicle of the invention, the forward pedal and the reverse pedal can commonly be used. Therefore, management cost can be reduced as the component in the forward pedal and the reverse pedal, and the cost reduction can be achieved from the viewpoint of the component management. The bent portions are provided at two points in one operating pedal, so that the antiskid effect can be improved. Particularly, in the operating pedal having the structure in which the irregular-shaped end faces are provided at both right and left end portions while the bent portions are provided in the center of the right and left direction, the irregular-shaped end faces constitute the slip stopper in the front-back direction and the bent shapes constitute the slip stopper in the right and left direction with respect to the shoe sole, so that the sufficient antiskid effect can be obtained in the front-back and right and left directions.

In the pedal structure for traveling vehicle of the invention, the friction portion can easily be formed by using the friction member such as a washer or by forming a frictional shape such as screw forming. Therefore, the antiskid effect can simply be obtained at low cost in the rod-shaped operating pedal by utilizing the already-existing member or facilities in a plant.

In the pedal structure for traveling vehicle of the invention, the hot air of the engine can be prevented from blowing to the feet of the driver of the driving portion from the guide portion communicated with the engine room with the simple and durable structure.

### BRIEF DESCRIPTION OF THE DRAWINGS

FIG. 1 is an entire side view showing a tractor backhoe loader which is of an example of a work vehicle in which a working machine is attached to a traveling vehicle according to an embodiment of the invention.

FIG. 2 is a plan view showing a device configuration from a layout plate to HST.

FIG. 3 is a perspective view showing a configuration of a brake operation device.

FIG. 4 is a perspective view showing a backside of the layout plate.

FIG. 5 is a side view showing the layout plate.

FIG. 6 is a view showing a forward pedal and a reverse pedal, FIG. 6(a) is a perspective view of the forward pedal and the reverse pedal, and FIG. 6(b) is a side view of the forward pedal and the reverse pedal.

FIG. 7 is a view showing a forward pedal and a reverse pedal according to another embodiment of the invention, FIG. 7(a) is a perspective view of the forward pedal and the reverse pedal, and FIG. 7(b) is a side view of the forward pedal and the reverse pedal.

FIG. 8 is a perspective view showing an example of a configuration of a friction portion in a brake pedal.

FIG. 9 is a view showing a master brake pedal, FIG. 9(a) is a perspective view of the master brake pedal, FIG. 9(b) is a plan view of the master brake pedal, and FIG. 9(c) is a side view of the master brake pedal.

FIG. 10 is a view showing a master brake pedal according to another embodiment of the invention, FIG. 10(a) is a perspective view of the master brake pedal, FIG. 10 (b) is a plan view of the master brake pedal, and FIG. 10(c) is a side view of the master brake pedal.

FIG. 11 is a perspective view showing a mold member.

FIG. 12 is a perspective view showing a state in which the mold member is attached.

### EXPLANATIONS OF LETTERS OR NUMERALS

2 traveling vehicle
8 hood
9 driving portion
13 layout plate (plate member)
13g guide portion
21 forward pedal
21a forward pedal rod (rod portion)
21f stepping surface
22 reverse pedal
22a reverse pedal rod (rod portion)
22f stepping surface
41 left brake pedal
41a rod portion
42 right brake pedal
42a rod portion
43 master brake pedal
43a pedal rod
43f stepping surface
60 end face
61 bent portion
62 identification mark
90 flat portion
91 bent portion
92 end face
100 mold member
101 closed portion
102 clipping portion

### BEST MODE FOR CARRYING OUT THE INVENTION

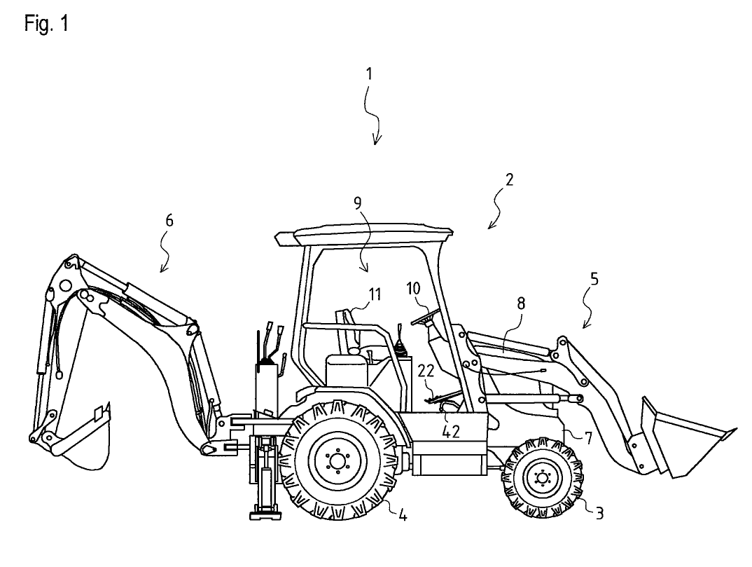

An embodiment of the invention will described below. In the following description, it is assumed that front is a forward direction of the traveling vehicle, rear is an opposite direction to the forward direction, and right and left are right and left directions with respect to the forward direction. FIG. 1 is an entire side view showing a tractor backhoe loader 1 which is of an example of a work vehicle in which a working machine is attached to a traveling vehicle according to an embodiment of the invention. In the tractor backhoe loader 1, a main machine is a traveling vehicle 2 having right and left front wheels 3 and right and left rear wheels 4. A loader 5 which is of a loading machine is attached to a front side of the traveling vehicle 2, and a drill rig 6 is attached to the rear side of the traveling vehicle 2. A hood 8 is provided in a front portion of a vehicle body frame 7 of the traveling vehicle 2 and above the front wheel 3. An engine (not shown) mounted on the vehicle body frame 7 is covered with the hood 8. An engine room is formed in the hood 8, and the engine and accessory instruments such as a radiator, a muffler, and an air cleaner are disposed in the engine room.

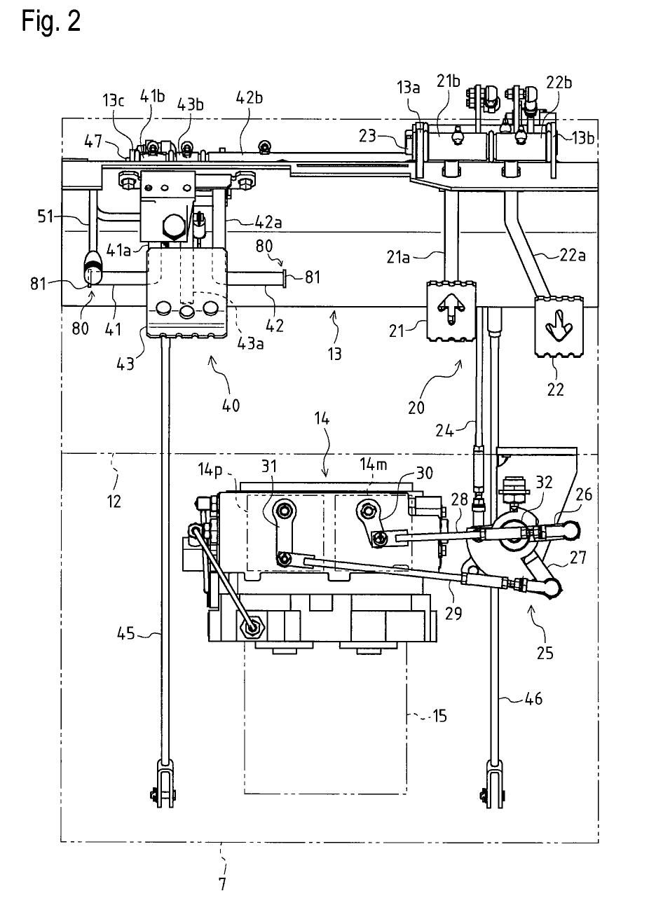

A driving portion (steering portion) 9 is formed at the back of the hood 8. A steering wheel 10 and a seat 11 are provided in the driving portion 9. Manipulating devices of the loader 5 and drill rig 6 are provided near the seat 11. A forward pedal 21, a reverse pedal 22, and brake pedals (41, 42, and 43) which are of the operating pedal of the traveling vehicle 2 are provided in the driving portion 9 (see FIG. 2). The running manipulation of the traveling vehicle 2 and the work manipulations of the loader 5 and drill rig 6 can be performed in the driving portion 9.

As shown in FIG. 2, a step 12 which becomes a foot hold of the driver is placed in the vehicle body frame 7, and a layout plate 13 which is of the plate member is disposed in front of the step 12. Various operating pedals are provided in the layout plate 13. HST 14 is disposed back below the step 12, a gear box 15 in which a planetary gear mechanism is mounted is disposed at the back of HST 14, and HST 14 and the gear box 15 constitute HMT (Hydro Mechanical Transmission).

A gear shift operation device 20 is disposed on the right side of the layout plate 13. A forward pedal 21 and a reverse pedal 22 which are of the operating pedal of the traveling vehicle 2 are disposed in the gear shift operation device 20. A schematic configuration of the gear shift operation device 20 will be described. The forward pedal 21 and the reverse pedal 22 are fixed to front-end portions of a forward pedal rod 21a and a reverse pedal rod 22a which are of the rod portion. The forward pedal rod 21a and the reverse pedal rod 22a are rotatably supported by a rotating support shaft 23 supported on the backside of the layout plate 13. That is, the rotating support shaft 23 is supported in the right and left directions by stays 13a and 13b projected at two points on the backside of the layout plate 13, and a forward pedal rotating cylinder 21b constituting a based portion of the forward pedal rod 21a and a reverse pedal rotating cylinder 22b constituting a based portion of the reverse pedal rod 22a are rotatably supported by the rotating support shaft 23.

The forward pedal 21 and the reverse pedal 22 are interlocking-coupled to a link 24 through a link mechanism (not shown), and the forward pedal 21 and the reverse pedal 22 are coupled to a swash plate tilt angle manipulation mechanism 25. The link mechanism is formed by the forward pedal rotating cylinder 21b and an arm extended from the reverse pedal rotating cylinder 22b. At this point, the link 24 is moved forward by the link mechanism when the forward pedal 21 is manipulated, the link 24 is moved backward when the reverse pedal 22 is manipulated. Therefore, the swash plate tilt angle manipulation mechanism 25 is manipulated while interlocked with the link 24. The gear shift operation device 20 is interlocking-coupled to control arms 30 and 31 of a hydraulic motor 14m and a hydraulic pump 14p of HST 14 though the swash plate tilt angle manipulation mechanism 25. The swash plate tilt angle manipulation mechanism 25 includes a first arm 26 and a second arm 27. The first arm 26 is interlocking-coupled to a control arm 30 of the hydraulic motor 14m through a motor control link 28. The second arm 27 is interlocking-coupled to a control arm 31 of the hydraulic pump 14p through a pump control link 29. The first and second arms 26 and 27 are rotatably supported on the same rotating support shaft 32, and the first and second arms 26 and 27 are interlocking-coupled to each other. The first arm 26 and the second arm 27 are rotated by the interlock with the stepping of the forward pedal 21 or the reverse pedal 22, and the swash plate tilt angles of the hydraulic motor 14m and hydraulic pump 14p of HST 14 are changed to perform speed setting and the switch between forward and reverse.

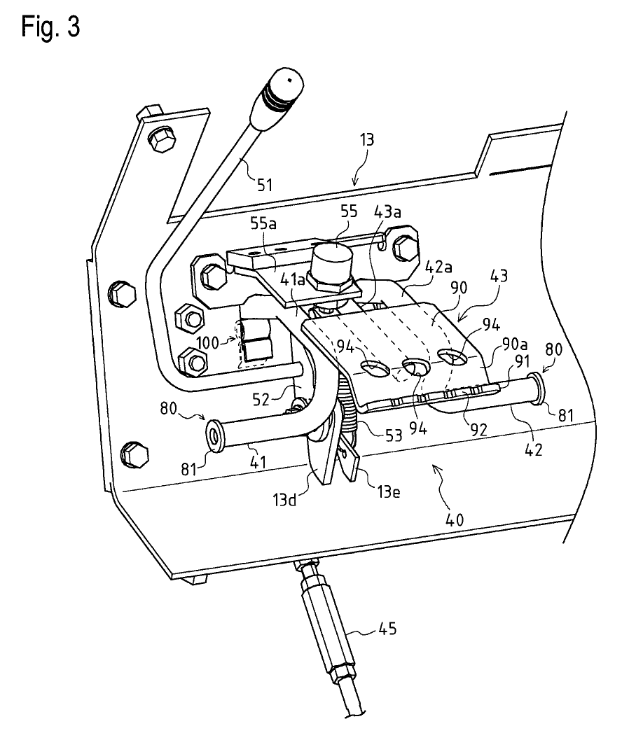

On the other hand, a brake operation device 40 is disposed on the left side of the layout plate 13. A left brake pedal 41, a right brake pedal 42, and a master brake pedal 43 are provided in the brake operation device 40. The left brake pedal 41 and the right brake pedal 42 are of the operating pedal, and the master brake pedal 43 is used to simultaneously manipulate both the brake pedals 41 and 42. The right and left brake pedals 41 and 42 are coupled to a brake device (not shown) through links 45 and 46 respectively. A schematic configuration of the brake operation device 40 will be described with reference to FIGS. 3 to 5. A rotating support shaft 47 having the substantially same length as a width in the right and left direction of the layout plate 13 is provided in the right and left direction on the backside of the layout plate 13. The rotating support shaft 47 is provided between a stay 13c and the stay 13b which are projected on the backside of the layout plate 13. A left brake rotating shaft 41b, a right brake rotating cylinder 42b, and a master brake rotating cylinder 43b are rotatably supported by the rotating support shaft 47. The left brake pedal 41 is fixed to the left brake rotating shaft 41b through a rod portion 41a. The right brake pedal 42 is fixed to the right brake rotating cylinder 42b through a rod portion 42a. The master brake pedal 43 is fixed to the master brake rotating cylinder 43b through a rod portion 43a which is of the rod portion.

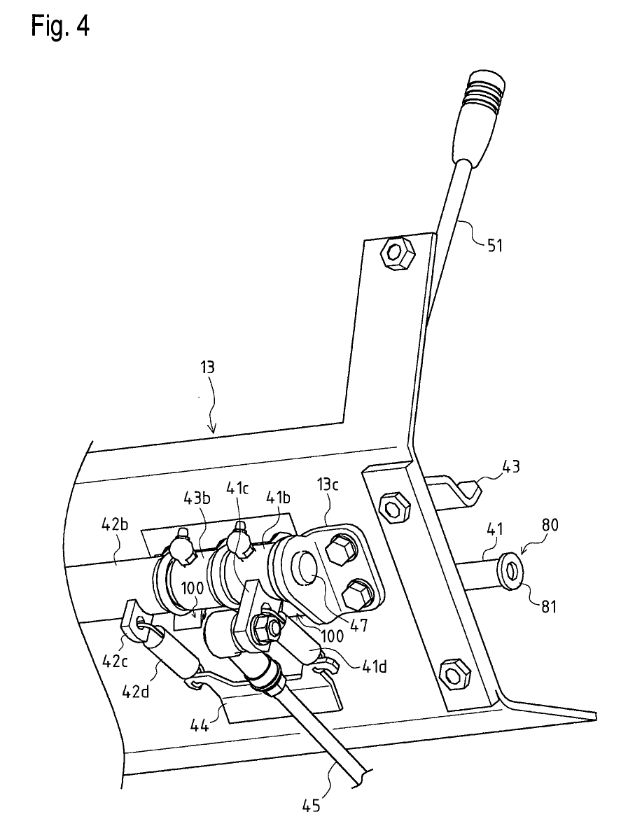

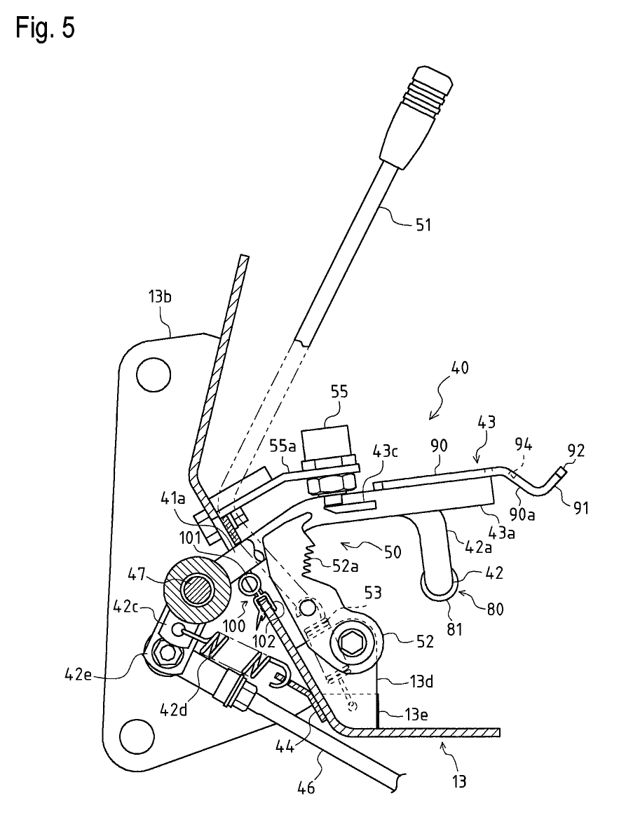

As shown in FIG. 4, arms 41c and 42c are projected toward an obliquely-front downward direction from the left brake rotating cylinder 41b and the right brake rotating cylinder 42b respectively. The arms 42c and 42c are latched in a hook latching plate 44 fixed to the layout plate 13 through the return springs 41d and 42d. In FIG. 5, the brake rotating cylinders 41b and 42b are biased counterclockwise (upward) by the return spring 41d and 42d, and the brake pedals 41 and 42 are pulled up to disable the brake in the state in which the stepping manipulation is not performed. The link 45 which is of the coupling body coupled to the brake device of the right running wheel is coupled to a right end portion of the left brake rotating cylinder 41b through the arm 41c. On the other hand, a link 46 which is of the coupling body coupled to the brake device of the left running wheel is coupled to the right brake rotating cylinder 42b through the arm 42e projected in the right brake rotating cylinder 42b. Therefore, according to the manipulations of the left brake pedal 41 and right brake pedal 42, the links 45 and 46 are independently manipulated and braking of the right and left running wheels can independently be performed.

The left brake pedal 41 and the rod portion 41a are formed by bending one rod-shaped body. The left brake pedal 41 is bent obliquely downward from the rod portion 41a extended from the left brake rotating cylinder 41b toward the obliquely-rear upward direction, and the left brake pedal 41 is bent leftward and extended leftward in the substantially horizontal direction. The right brake pedal 42 and the rod portion 42a are formed by bending one rod-shaped body. The right brake pedal 42 is bent obliquely downward from the rod portion 42a extended from the right brake rotating cylinder 42b toward the obliquely-rear upward direction, and the right brake pedal 42 is bent rightward and extended rightward in the substantially horizontal direction.

The master brake pedal 43 is formed by a plate-like member attached to the pedal rod 43a which is of the rod portion. The rod portion is extended from the master brake rotating cylinder 43b toward the obliquely-rear upward direction between the right and left rod portions 41a and 42a. The master brake pedal 43 is disposed above the rod portion 41a of the left brake pedal 41 and the rod portion 42a of the right brake pedal 42. That is, the master brake pedal 43 is disposed in the substantial center between the left brake pedal 41 and the right brake pedal 42, and the master brake pedal 43 overlaps the right and left rod portions 41a and 42a when viewed from above. Therefore, when the stepping manipulation is performed to the master brake pedal 43, the rod portions 41a and 42a are pressed by the master brake pedal 43, and whereby the right and left brake pedals 41 and 42 are simultaneously manipulated.

Thus, in the brake operation device 40, the braking of the right and left running wheels can independently be performed by manipulating the right and left brake pedals 41 and 42, and the braking of the right and left running wheels can simultaneously be performed by manipulating the master brake pedal 43.

A parking lock mechanism 50 is provided in the brake operation device 40. In the parking, the parking lock mechanism 50 is used to lock up by stepping the master brake pedal 43 while the right and left brakes are put on. The parking lock mechanism 50 includes a parking lever 51 manipulated in parking and a rotating arm 52 to which a base end portion of the parking lever 51 is fixed while piercing therethrough. The rotating arm 52 is rotatably supported by a stay 13d projected from the layout plate 13, and an engagement portion 52a is formed in the rotating arm 52 to retain the state in which the master brake pedal 43 is stepped.

As described above, the base end portion of the parking lever 51 is fixed while piercing through the rotating arm 52, and the rotating arm 52 is rotated while interlocked to the operation of the parking lever 51. In the parking lever 51, one end side of the return spring 53 is latched in the portion which is projected while piercing through the rotating arm 52. The other end side of the return spring 53 is latched in a latching portion 13e projected from the layout plate 13. Therefore, the rotating arm 52 is biased counterclockwise in FIG. 5. The engagement portion 52a formed in the rotating arm 52 is provided so as to face an engagement piece 43c which is formed in a sawtooth shape while fixed to the pedal rod 43a of the master brake pedal 43. The engagement piece 43c engages one of valleys in the engagement portion 52a of the rotating arm 52.

In the brake operation device 40, the pedal rod 43a is rotated clockwise in FIG. 5 by the stepping manipulation of the master brake pedal 43 in parking. On the other hand, because the parking lever 51 is similarly rotated clockwise in FIG. 5, the rotating arm 52 is rotated clockwise against the biasing force of the return spring 53, and the engagement portion 52a engages the engagement piece 43c of the pedal rod 43a. Therefore, the rotation of the rotating arm 52 is regulated to maintain the state in which the master brake pedal 43 is stepped.

A limit switch 55 is provided in the brake operation device 40. The limit switch 55 detects the manipulation states of the master brake pedal 43 and parking lever 51 by contacting the engagement piece 43c and rotating arm 52. The limit switch 55 is attached to a stay 55a fixed to the layout plate 13. The engine can be started up only when the limit switch 55 detects that master brake pedal 43 is stepped and only when the limit switch 55 detects that parking lever 51 is located at the position where the engagement between the engagement portion 52a of the rotating arm 52 and the engagement piece 43c is released. Therefore safety is ensured.

The configurations of the operating pedals provided in the layout plate 13 of the traveling vehicle 2, i.e., the configurations of the forward pedal 21 and reverse pedal 22 of the gear shift operation device 20 and the left brake pedal 41, right brake pedal 42, and master brake pedal 43 of the brake operation device 40 will be described below.

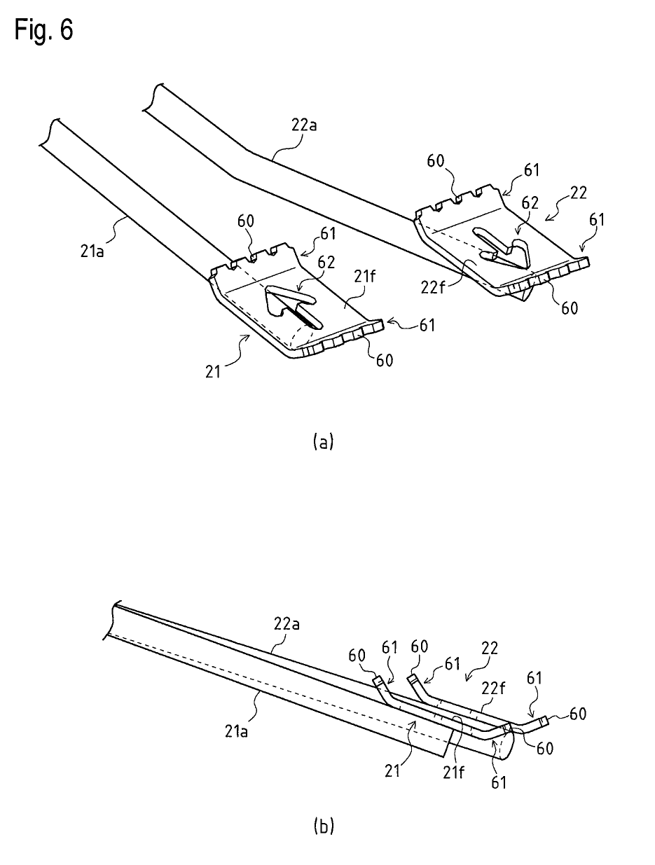

The forward pedal 21 and the reverse pedal 22 will be described with reference to FIG. 6. As described above, the forward pedal 21 and reverse pedal 22 which are formed in the substantially rectangular plate shape are fixed to the front-end portions of the forward pedal rod 21a and reverse pedal rod 22a which are of the rod portion respectively. The bent portions 61 are provided in the end portions of the forward pedal 21 and reverse pedal 22. The bent portions 61 have the irregular-shaped end face 60, and the bent portions 61 are bent toward the sides of stepping surfaces 21f and 22f. That is, in the substantially rectangular plate-like member, the end portions (front and rear end portions in the embodiment) are formed in the tooth form to form the irregular end face, the end portion on the side of the irregular-shaped end face 60 is bent toward the sides of the stepping surfaces 21f and 22f, i.e., the upward direction to form the bent portion 61.

Thus, the antiskid effect can sufficiently be obtained with the simple and inexpensive configuration and the simple shape by providing the bent portions 61 in the forward pedal 21 and reverse pedal 22 which are of the operating pedal. That is, when compared with the conventional stepping surface formed in the substantial plane or slightly curved surface, the bent shapes of the bent portions 61 which are projected from the stepping surfaces 21f and 22f abut on the shoe sole of the driver to act as the slip stopper by bending the end portion of the plate-like pedal in the front-back direction, and the irregular-shaped end face 60, which becomes front and rear end faces of each pedal, of the bent portion 61 creates friction with the shoe sole of the driver to act as the slip stopper in the right and left direction, so that the antiskid effect can sufficiently be obtained. In the plate-like forward pedal 21 and reverse pedal 22, the irregular-shaped end face 60 and the bent plate are formed by press working, so that the bent portion 61 can simply be formed at low cost. Even if the burr is generated in the bent portion 61 by the press working, the burr is used as the slip stopper. Therefore, the burr generated in the press working can effectively be used to simplify the manufacturing process.

The positions where the bent portions 61 are provided are not limited to the front and rear end portions like the embodiment, but the bent portions 61 may be provided in the right and left end portions.

In this case, the irregular-shaped end face of the bent portion 61 creates friction with the shoe sole of the driver to act as the slip stopper in the front-back direction, and the bent shapes of the bent portions 61 which are projected from the stepping surfaces 21f and 22f abut on the shoe sole of the driver to act as the slip stopper in the front-back direction, so that the antiskid effect can be obtained. In providing the bent portion 61, although a bending angle of the bent portion 61 to the stepping surfaces 21f and 22f is not particularly limited, preferably the bending angle becomes an obtuse angle in consideration of the easy press working and the function of the operating pedal.

The identification marks 62 indicating the forward and reverse are provided in the forward pedal 21 and the reverse pedal 22 by punching respectively. In the embodiment, the identification marks 62 used to determine the forward and reverse is provided by punching the arrow shape from the plate-like pedal, the forward arrow is shown in the forward pedal 21, and the reverse arrow is shown in the reverse pedal. The identification mark 62 is not limited to the arrow shape. Alternatively, any shape such as a triangular shape whose apex indicates the direction may be used as long as the determination of the forward and reverse is easily made and as long as the punching is easily performed. The plural punching positions may be formed in the identification mark 62 in consideration of pedal strength.

Thus, in the forward pedal 21 and the reverse pedal 22, the identification mark 62 indicating the forward and reverse is provided by punching, so that the identification mark 62 and the bent portion 61 which can be provided by press working can be provided in the same process. Therefore, the number of processes is not increased when the identification mark 62 is provided, and the simplified manufacturing process and the cost reduction can be achieved. Additionally, when compared with the conventional technique of bonding the rubber plate having the identification mark such as the arrow to the operating pedal, the simplified manufacturing process and cost reduction can be achieved.

Preferably the bent portions 61 provided in the forward pedal 21 and reverse pedal 22 are provided in opposite end portions of each of the pedals 21 and 22, and the forward pedal 21 and the reverse pedal 22 are formed in the same shape including the identification mark 62. That is, as shown in FIG. 6, while the bent portions 61 are provided in front and rear end portions of each of the pedals 21 and 22, the identification mark 62 (arrow shape) is formed so as to indicate one direction (forward or reverse) in each of the pedals 21 and 22. Therefore, the pedal 21 and 22 are formed in the same shape including the identification mark 62 as a whole.

Thus, the bent portions 61 are provided in opposite end portions of each of the pedals 21 and 22 to form the forward pedal 21 and the reverse pedal 22 in the same shape, which allows the forward pedal and the reverse pedal to be commonly used. That is, in fixing the forward pedal 21 and reverse pedal 22 to the forward pedal rod 21a and reverse pedal rod 22a, the identification mark 62 is used as not only the forward pedal indicating forward but also the reverse pedal indicating reverse by orientating the operating pedals toward opposite front-back directions, and the whole shape of each pedal performs the same function. Therefore, the management cost can be reduced as the component in the forward pedal 21 and the reverse pedal 22, and the cost reduction can be achieved from the viewpoint of the component management. The bent portions 61 are provided at two points in one operating pedal, so that the antiskid effect can be improved. At this point, the bent portions 61 at two points can be provided in the same process of press working, so that the simple and inexpensive configuration can be maintained while the number of manufacturing process is not increased. In providing the bent portions 61 in the opposite end portions in the forward pedal 21 and reverse pedal 22, the bent portions 61 are provided in the end portions of the front-back direction in the embodiment. Alternatively, the bent portions 61 may be provided in the right and left end portions of the pedals 21 and 22.

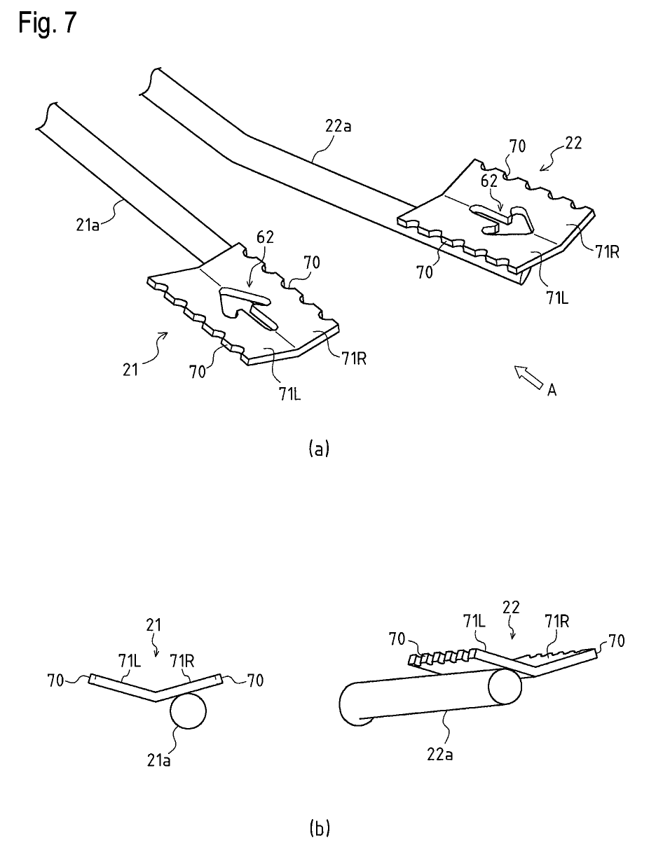

A forward pedal 21 and a reverse pedal 22 according to another embodiment of the invention will be described below with reference to FIG. 7. The same portion as the above-described embodiment is designated by the same numeral, and the description is omitted. In the embodiment, each of the substantially-rectangular pedals 21 and 22 fixed to the pedal rods 21a and 22a is bent at the substantially central position to form the left half portion 71L and a right half portion 71R as a whole. The end faces of the left half portion 71L and right half portion 71R, i.e., right and left end faces of each of the pedal 21 and 22 are formed in an irregular-shaped end face 70. In this case, in each of the pedals 21 and 22, the bent portion is formed by both the left half portion 71L and the right half portion 71R.

As shown in FIG. 7(b), in the forward pedal 21 located on the left side of the reverse pedal 22, the right half portion 71R is fixed to the forward pedal rod 21a, thereby fixing the right half portion 71R to the forward pedal rod 21a. In the reverse pedal 22 located on the right side of the forward pedal 21, the left half portion 71L is fixed to the reverse pedal rod 22a, thereby fixing the left half portion 71L to the reverse pedal rod 22a. FIG. 7(b) shows the forward pedal rod 21a when viewed from an arrow of FIG. 7(a).

In the configuration of FIG. 7, for the forward pedal 21 and the reverse pedal 22, the sufficient antiskid effect can be obtained and safety can be improved by the simple and inexpensive configuration and the simple shape. That is, as described above, the right half portion 71R is provided while fixed to the pedal rod 21a in the forward pedal 21 located on the left side, and the left half portion 71L is provided while fixed to the pedal rod 22a in the reverse pedal 22 located on the right side, so that a distance between the forward pedal 21 and the reverse pedal 22 can be widened in the right and left direction. Therefore, the shoe of the driver can be prevented from being caught between the forward pedal 21 and the reverse pedal 22, and the safety can be improved. Each of the forward pedal 21 and the reverse pedal 22 is formed in the bent shape including the left half portion 71L and right half portion 71R having the irregular-shape end faces 70. Thus, the irregular-shaped end face 70 which becomes the right and left end faces of each of the pedal 21 and 22 creates friction with the shoe sole of the driver to act as the slip stopper in the front-back direction, and the bent shape formed by the left half portion 71L and right half portion 71R acts as the slip stopper by bending the end portion of the plate-like pedal in the right and left direction, so that the antiskid effect can sufficiently be obtained in the front-back direction and the right and left direction. In the plate-like forward pedal 21 and reverse pedal 22, the irregular-shaped end face 70 and the bent plate are formed by press working, so that plate-like forward pedal 21 and reverse pedal 22 can simply be formed at low cost.

Then, the left brake pedal 41 and the right brake pedal 42 will be described. As described above, the left brake pedal 41 and the right brake pedal 42 and the corresponding rod portions 41a and 42a are made to form rod-shape stepping portions by bending one rod-shape body respectively. The rod-shape stepping portion is provided in the substantially horizontal direction. A friction portion 80 is formed in each of the right and left brake pedal 41 and 42. That is, as shown in FIGS. 2 to 5, in the rod-shape right and left brake pedals 41 and 42, an enlarged-diameter portion 81 is formed in the front end portion of the friction portion 80. Specifically, the enlarged-diameter portion 81 is formed in the friction shape by fixing the friction member to each of the right and left brake pedal 41 and 42. For example, a washer is used as the friction member, and the washer is fixed to a front-end face of each of the right and left brake pedal 41 and 42 by welding.

Thus, in the rod-shape right and left brake pedals 41 and 42, the enlarged-diameter portion 81 is formed as the friction portion 80 in the front-end portion, so that the antiskid effect can be obtained with the simple and inexpensive configuration. The enlarged-diameter portion 81 formed in each of the brake pedals 41 and 42 creates friction with the shoe sole of the driver to act as the slip stopper in the right and left direction of each of the brake pedals 41 and 42. The enlarged-diameter portion 81 is formed by welding the washer, so that the friction portion 80 can easily be formed at low cost by utilizing the already-existing member.

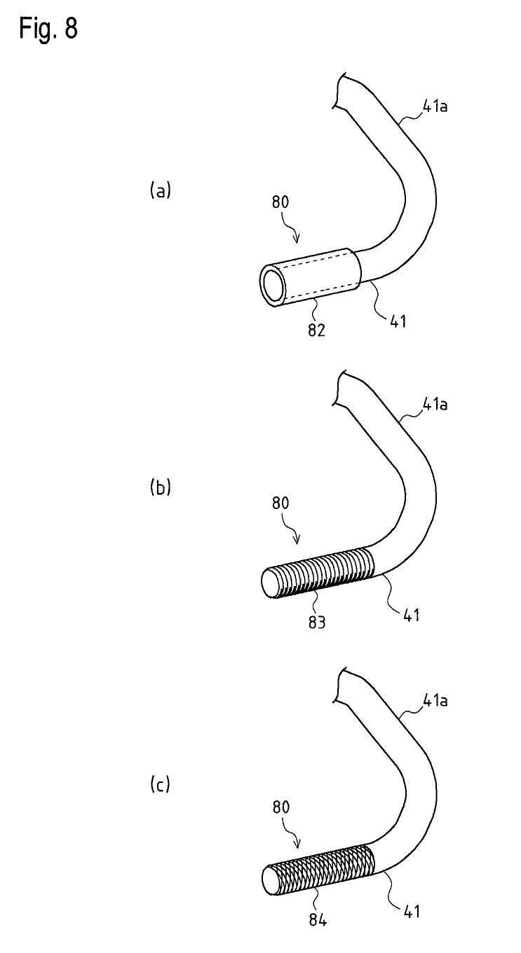

The friction portion 80 provided in each of the right and left brake pedals 41 and 42 may be formed as follows. A friction portion 80 according to still another embodiment of the invention will be described with reference to FIG. 8. Because the left brake pedal 41 and right brake pedal 42 are formed in the substantially symmetrical manner, only the left brake pedal 41 is shown in FIG. 8.

As shown in FIG. 8(a), a hose member 82 made of an elastic material such as synthetic rubber which is of the friction member is attached to each of the right and left brake pedal 41 and 42 to form the friction portion 80. The cylindrical hose member 82 is attached to each of the rod-shape right and left brake pedal 41 and 42, and the friction portion 80 is formed by coating the surface of each of the right and left brake pedal 41 and 42 with the elastic material having a friction coefficient higher than that of metal which is of the material of the brake pedal 41 and 42. Thus, the antiskid effect can be obtained with the simple and inexpensive configuration by utilizing the hose member 82 made of the elastic material as the friction member.

As shown in FIGS. 8(b) and 8(c), the right and left brake pedals 41 and 42 is formed in the friction shape, which allows the friction portion 80 to be formed in the right and left brake pedals 41 and 42. That is, as shown in FIG. 8(b), the right and left brake pedals 41 and 42 are threaded to form a thread portion 83, whereby the friction shape is performed to each of the right and left brake pedals 41 and 42 to form the friction portion 80. As shown in FIG. 8(c), knurling is performed each of the right and left brake pedals 41 and 42 to form a knurling portion 84, whereby the friction shape is performed to each of the right and left brake pedals 41 and 42 to form the friction portion 80.

Thus, the friction shape such as the threaded shape and the knurling shape is performed to each of the right and left brake pedals 41 and 42 to form the friction portion 80, which allows the antiskid effect to be obtained with the simple and inexpensive configuration. That is, when the threaded portion 83 or the knurling portion 84 is performed to each of the right and left brake pedals 41 and 42 to perform the friction shape, many irregularities are formed in the surface of each of the brake pedal 41 and 42 to easily catch the shoe sole, so that the friction with the shoe sole of the driver can be increased to obtain the antiskid effect. The threading for forming the threaded portion 83 and the knurling for forming the knurling portion 84 is performed by utilizing the already-existing facilities in a plant, so that the friction portion 80 can simply be formed at low cost.

Then, the master brake pedal 43 will be described. As described above, the master brake pedal 43 is formed by the plate-like member added to the pedal rod 43a. As shown in FIGS. 3, 5, and 9, similarly to the forward pedal 21 and reverse pedal 22, a bent portion 91 is provided in the master brake pedal 43. The bent portion 91 has an irregular-shape end face 92, and the bent portion 91 is bent toward the side of a stepping surface 43f. A flat portion 90 is provided in the master brake pedal 43. In the flat portion 90, the master brake pedal 43 in which the bent portion 91 is formed can be bent in a multi-step manner.

The flat portion 90 is a flat plate portion formed in the substantially rectangular shape. In the flat portion 90, an inclined-surface portion 90a is formed by bending the flat portion 90 while inclined toward the rear downward direction from the backside of the flat portion 90, and the bent portion 91 is formed by bending the flat portion 90 from the backside of the inclined-surface portion 90a. In the master brake pedal 43 formed by one plate-like member, the backside of the master brake pedal 43 is bent in the multi-step manner so as to be in a reversely V-shape, and the end face is formed in the irregular shape. Therefore, the flat portion 90 and the bent portion 91 are formed. The bent portion 91 is provided while the inclined-surface portion 90a is interposed between the flat portion 90 and the bent portion 91. The pedal rod 43a is fixed to the substantial center in the right and left direction of the flat portion 90, thereby fixing the master brake pedal 43 to the pedal rod 43a. The flat portion 90 presses the rod portions 41a and 42a of the right and left brake pedals 41 and 42 when the master brake pedal 43 is stepped.

Thus, when the flat portion 90 and the bent portion 91 are provided in the master brake pedal 43 which is of the operating pedal, the pressure against the shoe sole can be reduced from the end face 92 of the bent portion 91 formed in the irregular shape in the operating pedal to which the large stepping force is applied. Therefore, damage of the shoe sole of the driver can be prevented. In the case where the flat portion 90 is provided, the antiskid effect by the bent portion 91 can be ensured by the irregular shape of the end face 92 of the bent portion 91.

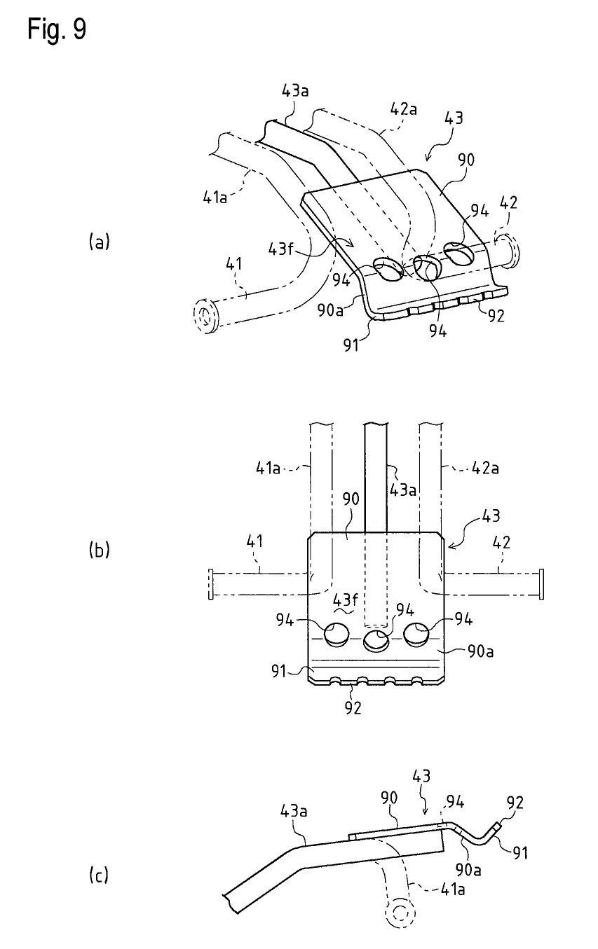

In the master brake pedal 43, one or plural holes 94 (three holes in FIG. 9) are made in a folded portion between the flat portion 90 and the inclined-surface portion 90a. That is, the hole 94 is made in the portion where the master brake pedal 43 is bent from the backside of the flat portion 90 toward the rear downward direction to form the irregular shape in the folded portion between the flat portion 90 and the inclined-surface portion 90a.

The sufficient antiskid effect can be obtained with the simple and inexpensive configuration and the simple shape by forming the master brake pedal 43 in the above-described way. That is, the bent shapes of the bent portions 91 formed by bending the flat portion 90 acts as the slip stopper in the front-back direction, and the irregular-shaped end face 92 of the bent portion 91 and the irregular shape end formed by the holes 94 in the folded portion between the flat portion 90 and the inclined-surface portion 90a creates friction with the shoe sole of the driver to act as the slip stopper in the right and left direction, so that the antiskid effect can sufficiently be obtained in the front-back direction and the right and left direction. In the plate-like master brake pedal 43 having the flat portion 90 and bent portion 91, the irregular-shaped end face 92, the bent shape, and the hole 94 are made by press working, so that the plate-like master brake pedal 43 can easily be formed at low cost. Because the end face is not formed on the lower surface side of the master brake pedal 43, even if the shoes of the driver enters the lower side of the master brake pedal 43, scratch of the shoes can be prevented.

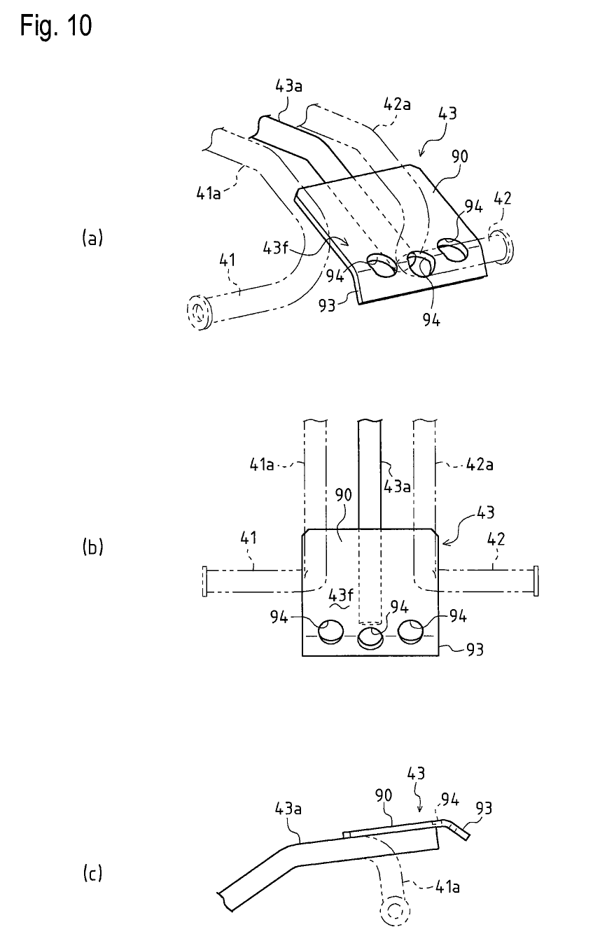

Then, a master brake pedal 43 according to still another embodiment of the invention will be described below with reference to FIG. 10. The same portion as the above-described embodiments is designated by the same numeral, and the description is omitted. As shown in FIG. 10, in the master brake pedal 43, an inclined portion 93 is provided in the flat portion 90 while bent from the backside of the flat portion 90 toward the rear downward direction, and one or plural holes 94 (three holes in FIG. 10) are made in the folded portion between the flat portion 90 and the inclined portion 93. That is, as shown in FIG. 10(c), in the master brake pedal 43, the bent portion 91 is omitted in the previous embodiment, the flat portion 90 and the inclined portion 93 form the master brake pedal 43 in the reverse V-shape when viewed from the side. As shown FIGS. 10(a) and 10(b), the irregular shape is formed in the folded portion between the flat portion 90 and the inclined portion 93 by making the holes 94.

Even in the configuration of FIG. 10, for the master brake pedal 43, the antiskid effect can sufficiently be obtained with the simple and inexpensive configuration and the simpler shape. The flat portion 90 and the inclined portion 93 form the master brake pedal 43 in the reverse V-shape, whereby the folded portion between the flat portion 90 and the inclined portion 93 abuts easily on the shoe sole of the driver. The irregular shape is formed by making the holes 94. Therefore, the antiskid effect can be obtained with the simpler shape in the front-back direction and the right and left direction. In manufacturing the master brake pedal 43, the punching is performed from the backside toward the side of the stepping surface 43f, the small irregular shapes caused by the burr are formed toward the side of the stepping surface 43f in the end face of the inclined portion 93. The antiskid effect can also be obtained by the irregular shape formed in the manufacturing process. In this case, in the master brake pedal 43, the inclined portion 93 and the hole 94 are formed by press working, and the inclined portion 93 and the hole 94 have the simpler shapes. Therefore, the master brake pedal 43 can more easily be formed at low cast.

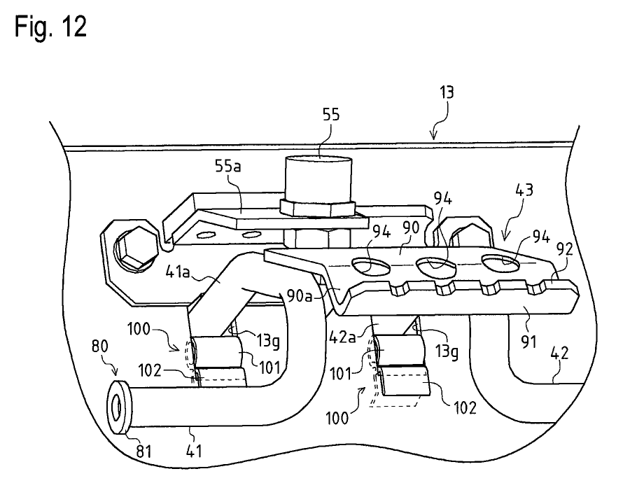

In the brake operation device 40, the left brake pedal 41 and right brake pedal 42 which are of the operating pedal are provided through the rod portion 41a and 42a extended into the driving portion 9. The layout plate 13 which is of the plate member in which the brake pedals 41 and 42 are disposed has a guide portion 13g. The rod portions 41a and 42a pierce through the guide portion 13g, the guide portion 13g permits rod portions 41a and 42a to be moved, and the guide portion 13g is communicated with engine room (inside of hood 8) of the traveling vehicle 2 (see FIG. 12). The rod portion 41a and 42a of the left brake pedal 41 and right brake pedal 42 are extended to the driving portion 9 through guide portions 13g formed by openings. The opening is provided in the layout plate 13 which separates the driving portion 9 and the engine room in the traveling vehicle 2. In the pedal structure, a mold member 100 is attached to the guide portion 13g to close a part of the guide portion 13g.

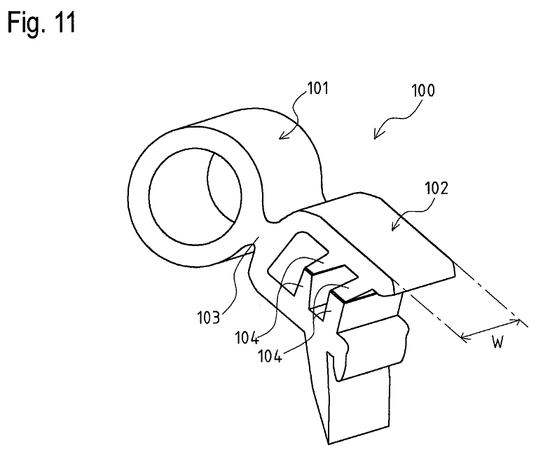

As shown in FIG. 11, the mold member 100 includes a closed portion 101 and a clipping portion 102. The closed portions 101 close the opening portions formed between the guide portions 13g and the rod portions 41a and 42a, and the elastic deformations of closed portions 101 permits the movements of the rod portion 41a and 42a. The clipping portion 102 clips the layout plate 13. The mold member 100 has a width substantially similar to that of the guide portion 13g. The mold member 100 is made of an elastically deformable material such as synthetic rubber and a synthetic resin. The elastic deformation of the mold member 100 permits the movements of the rod portion 41a and 42a, and the mold member 100 is attached to the layout plate 13. In the mold member 100, the closed portion 101 is formed in a pipe shape, and the closed portion 101 is flattened by the elastic deformation to permit the movements of the rod portion 41a and 42a. The clipping portion 102 is formed in a substantially U-shape when viewed from the side, and the clipping portion 102 forms a groove portion into which the plate-like layout plate 13 is inserted. The clipping portion 102 includes clipping pieces 104. The clipping pieces 104 clip the layout plate 13 in the guide portion 13g by the elastic deformations of the clipping pieces 104. The closed portion 101 and the clipping portion 102 are connected to each other by a connection portion 103.

The mold members 100 are attached below the rod portions 41a and 42a in the guide portions 13g of the layout plate 13 (see FIGS. 5 and 12). As described above, the rod portions 41a and 42a is rotatably supported by the rotating support shaft 47 through the right and left brake rotating cylinders 41b and 42b, and the rod portions 41a and 42a are biased upward by the return spring 41d and 42d. The rod portions 41a and 42a are located at the upper end positions in the state in which the left brake pedal 41 and right brake pedal 42 are not stepped (hereinafter referred to as “normal position”). At this point, the rod portions 41a and 42a are located in the upper end portions in the guide portion 13g, and the opening portion which is of the moving range is formed below each of the rod portion 41a and 42a in each of the guide portion 13g. The mold member 100 is attached to the opening portion below each of the rod portions 41a and 42a in the guide portion 13g.

In the state in which the mold member 100 is attached to the guide portion 13g of the layout plate 13, the guide portion 13g into which each of the rod portion 41a and 42a is inserted is formed in the substantially rectangular shape, a width in the right and left direction of the guide portion 13g is formed slightly larger than a diameter of each of the rod portions 41a and 42a so as to obstruct the movement of each of the rod portion 41a and 42a, and a vertical (front-back direction) length includes the moving range of each of the rod portion 41a and 42a. As described above, because the rod portions 41a and 42a at the normal positions are located at the upper end portions of the guide portions 13g, the mold members 100 are attached below the rod portions 41a and 42a in the guide portions 13g, which closes the opening portions while the rod portions 41a and 42a are located at the normal positions. That is, the mold member 100 has the substantially same width W as a whole (see FIG. 11) such that the width W is substantially equal to a width of the substantially-rectangular guide portion 13g. In the state in which the rod portion 41a and 42a are located at the normal positions, the mold member 100 is attached to the guide portion 13g such that the upper end of the closed portion 101 substantially contacts each of the rod portions 41a and 42a. Therefore, the opening portion below each of the rod portions 41a and 42a is closed in the guide portion 13g. When each of the brake pedals 41 and 42 is stepped from this state, the mold member 100 permits the movements of the portions 41a and 42a by the elastic deformation of the flattened closed portion 101, and the mold member 100 follows the movement of each of the portions 41a and 42a to maintain the closed state in which the opening portion below each of the rod portions 41a and 42a is closed in the guide portion 13g. When the stepping of each of the brake pedals 41 and 42 is released, the mold member 100 follows the movement of each of the rod portion 41a and 42a to the normal position by the elastic deformation of the closed portion 101, and the mold member 100 returns to the former shape while maintaining the closed state of the opening portion.

Thus, the mold members 100 are attached to the guide portions 13g of the rod portions 41a and 42a in the layout plate 13, so that the hot air of the engine can be prevented from blowing to the feet of the driver of the driving portion 9 from the guide portion 13g communicated with the engine room with the simple and durable structure. In the case where the opening portion is formed above each of the rod portions 41a and 42a in the guide portion 13g while the rod portions 41a and 42a are located at the normal positions, the mold members 100 can be attached below and above each of the rod portions 41a and 42a. Even in the configuration in which the rod portions 41a and 42a can be moved in the right and left direction, the mold members 100 can be attached so as to close the opening portions formed between the guide portion 13g and the rod portions 41a and 42a. In the case where other operating pedals such as the forward pedal 21 and the master brake pedal 43 are provided in the rod portion (pedal rod), the mold member 100 can also be applied to the guide portion into which the rod portion is inserted.

### INDUSTRIAL APPLICABILITY

In the pedal structure for traveling vehicle according to the invention, because the antiskid effect can sufficiently be obtained with the simple and inexpensive configuration and the simple shape, the invention has the advantage from the industrial viewpoint.

1. A pedal structure for traveling vehicle with an operating pedal,
characterized in that bent portions are provided in both right and left end portions of the operating pedal, the having an irregular shaped end face, the bent portion being bent such that both the right and left end portions are orientated toward a stepping surface side in the center in a right and left direction of the operating pedal.

2. (canceled)

3. The pedal structure for traveling vehicle according to claim 1, characterized in that an identification mark indicating running direction is provided in said operating pedal by punching.

4. The pedal structure for traveling vehicle according to claim 3, characterized in that not only the identification mark is used as a forward pedal indicating forward but also the identification mark is used as a reverse pedal indicating reverse by orientating said operating pedal toward opposite front-back directions.

5. (canceled)

6. A pedal structure for traveling vehicle according to claim 1, characterized in that a rod portion of said operating pedal is extended to a driving portion through a guide portion formed by an opening provided in a plate member, the driving portion and an engine room of the traveling vehicle being separated by the plate member, and
a mold member having a width substantially identical to that of said guide portion is attached to the said guide portion, the mold member includes a closed portion and a clipping portion, the closed portion permitting said rod portion to be moved by elastic deformation while closing an opening portion formed between the guide portion and said rod portion, the clipping portion clipping said plate member.
